(19) United States
(12) Patent Application Publication
(10) Pub. No.: US 2026/0134107 A1
(43) Pub. Date: May 14, 2026

(54) METHOD FOR SECURELY DEPLOYING A SOFTWARE FRAMEWORK ON A MACHINE LEARNING (ML) PLATFORM AND A SYSTEM THEREOF

(71) Applicant: Honeywell International Inc., Charlotte, NC (US)

(72) Inventors: Bhabesh Chandra Acharya, Bangalore (IN); Kotni Ashutosh, Bhubaneswar (IN); Manjunath Reddy S, Bangalore (IN); Kumaresh Baabu, Madurai (IN); Durga Prasad Rath, Bangalore (IN); Sudip Pradhan, Berhampur (IN)

(21) Appl. No.: 18/944,025

(22) Filed: Nov. 12, 2024

(51) Int. Cl. G06F 21/57

(52) U.S. Cl. CPC G06F 21/577

(57) ABSTRACT

The present disclosure provides a method for deploying the software framework on the ML Platform in a secure manner. In particular, the present disclosure provides a method for securely deploying the ML models or the algorithms into the system by providing a multi-level scanning procedure. In an embodiment, the disclosed method performs multiple vulnerability scans on the ML model or the algorithm at multiple stages to check for malware and ensure that only models/algorithms that pass the security checks are imported into the system. If the security scan detects vulnerabilities at any stage then the files are placed in a quarantined zone and the import process is terminated. Thereby protecting the system and making it cyber-secure.

### FIELD OF INVENTION

The present disclosure generally relates to a method for deploying software framework. In particular, the present disclosure provides a method for deploying the software framework on a Machine Learning (ML) Platform in a secure manner.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Generally, the developers, work on multiple software frameworks like ML models, or algorithms and perform testing of the developed software frameworks. The AI/ML platforms offer wide range of functionalities such as model training, lifecycle management, facilitating model deployment, monitoring model drift, handling model retraining, and redeployment. Further, in many cases, the ML models for an end user or a customer might already exist. Such ML models may leverage software frameworks developed by individual developers and the individual developers may consider deploying their software framework through the concept generally known as Bring Your Own Model (BYOML) where individuals or organizations bring their own machine learning models to the AI/ML platform or an environment for deployment and use it for performing various applications. Thus, the AI/ML platforms provide an option to import and bring models into the system. This enables greater flexibility and customization in AI applications.

Generally, while working on multiple software frameworks like ML models, or algorithms, the end users or the customers have to spend a significant time in setting up environments and deploying ML models. For example, tasks such as model import, training, deployment, scanning for vulnerabilities, and drift analysis require reliance on multiple tools. This leads to an increased effort, longer process durations, and potential security concerns. Further, during the development and deployment process, various vulnerabilities can get injected into the ML models or the algorithms. This causes potential security threats to the system where the ML models or the algorithms are deployed.

For example, considering a scenario where the ML model is developed for targets such as Kubernetes Pods and Edge Devices. The injection of vulnerabilities into the ML models during the development and deployment stages can pose security threats to these diverse systems. For instance, consider that a susceptible ML model, containing vulnerabilities is deployed on the Kubernetes Pods within the organization's infrastructure. These vulnerabilities could be exploited by malicious entities to compromise the security of the Kubernetes environment, potentially leading to threats like unauthorized access or manipulation of sensitive data. Likewise, if the same vulnerable ML model is deployed on edge devices for real-time data analysis, the vulnerabilities could be exploited to compromise the security and integrity of the edge devices, potentially leading to threats like unauthorized system access or data breaches. In both cases, the injection of vulnerabilities into ML models poses potential security threats to the system.

Thus, there is a need to provide a method for securely deploying a software framework with ML platforms.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a solution for securely deploying a software framework on a machine learning (ML) platform. Other implementations will be or will become, apparent to one with skill in the art upon examination of the following figures and detailed description. It is intended that all such additional implementations be included within this description within the scope of the disclosure.

According to an embodiment of the present disclosure, a method for secure deployment of a software framework on a Machine Learning (ML) platform is disclosed. The method includes receiving a request for a registration of the software framework with the ML platform. The request includes at least a link to the software framework and credentials information. The method further includes identifying a category of the software framework to be deployed on the ML platform. The software framework is at least one of a pre-trained machine learning (ML) model and an algorithm. Further, the method includes obtaining an access to one or more files associated with the identified category of the software framework based on the link and the credential information. The method further comprises performing a first vulnerability scan of the one or more files associated with the identified category of the software framework. Further, the method includes determining whether the first vulnerability scan is successful based on a result of the first vulnerability scan. Further, the method includes converting the one or more files associated with the identified category of the software framework into one or more deployable files for deployment with the ML platform based on the success of the first vulnerability scan. Further, the method includes performing a second vulnerability scan of the one or more deployable files and deploying the identified category of the software framework with the ML platform based on a determination that the second vulnerability scan is successful.

According to an embodiment of the present disclosure, a system for secure deployment of a software framework on a Machine Learning (ML) platform is disclosed. The system comprises one or more processors, a memory, and one or more programs stored in the memory. The one or more programs when executed by the one or more processors cause the one or more processors to receive a request for a registration of the software framework with the ML platform. The request includes at least a link to the software framework and credentials information. The one or more processors are further configured to identify a category of the software framework to be deployed on the ML platform. The software framework is at least one of a pre-trained machine learning (ML) model and an algorithm. The one or more processors are further configured to obtain an access to one or more files associated with the identified category of the software framework based on the link and the credential information. The one or more processors are further configured to perform a first vulnerability scan of the one or more files associated with the identified category of the software framework. The one or more processors are further configured to determine whether the first vulnerability scan is successful based on a result of the first vulnerability scan. The one or more processors are further configured to convert the one or more files associated with the identified category of the software framework into one or more deployable files for deployment with the ML platform based on the success of the first vulnerability scan. The one or more processors are further configured to perform a second vulnerability scan of the one or more deployable files and deploy the identified category of the software framework with the ML platform based on a determination that the second vulnerability scan is successful.

According to yet another embodiment, the present disclosure discloses a non-transitory computer-readable storage medium storing program instructions for evaluating risk associated with one or more network assets, the program instructions, when executed, perform the steps of receiving a request for a registration of the software framework with the ML platform. The request includes at least a link to the software framework and credentials information. The non-transitory computer-readable storage medium further comprises steps of identifying a category of the software framework to be deployed on the ML platform, wherein the software framework is at least one of a pre-trained machine learning (ML) model and an algorithm. The non-transitory computer-readable storage medium further comprises steps of obtaining an access to one or more files associated with the identified category of the software framework based on the link and the credential information. The non-transitory computer-readable storage medium further comprises steps of performing a first vulnerability scan of the one or more files associated with the identified category of the software framework. The non-transitory computer-readable storage medium further comprises steps of determining whether the first vulnerability scan is successful based on a result of the first vulnerability scan. The non-transitory computer-readable storage medium further comprises steps of converting the one or more files associated with the identified category of the software framework into one or more deployable files for deployment with the ML platform based on the success of the first vulnerability scan. The non-transitory computer-readable storage medium further comprises steps of performing a second vulnerability scan of the one or more deployable files. The non-transitory computer-readable storage medium further comprises steps of deploying the identified category of the software framework with the ML platform based on a determination that the second vulnerability scan is successful.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example environment of a system, according to an embodiment of the present disclosure;

FIG. 2 illustrates a detailed block diagram of the system, according to an embodiment of the present disclosure;

FIG. 3 illustrates an exemplary user interface (UI) for onboarding an ML code or an algorithm, according to an embodiment of the present disclosure;

FIG. 4 illustrates an exemplary user interface (UI) for onboarding an ML model, according to an embodiment of the present disclosure;

FIG. 5 illustrates general operation steps of the deployment process, according to an embodiment of the present disclosure;

FIG. 6 illustrates an operation flow for secure deployment of an ML code or algorithm with an ML platform, according to an embodiment of the present disclosure;

FIG. 7 illustrates an operation flow for a secure deployment of a pre-trained ML model with an ML platform, according to an embodiment of the present disclosure;

FIG. 8 illustrates a flow chart for a method for securely deploying the software framework in the ML platform, according to an embodiment of the present disclosure; and

FIG. 9 illustrates a general block diagram of the system, according to an embodiment of the present disclosure.

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details. Further, the reference numerals for similar components, modules, units, and operation steps have been kept same for the ease of understanding.

Some embodiments of the present disclosure now will be described with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements.

The present disclosure provides a method for securely deploying software frameworks into one or more end devices by providing a multi-level scanning procedure. In an embodiment, the disclosed method performs multiple vulnerability scans on the software frameworks at multiple levels to detect vulnerabilities at various stages of deployment. In a non-limiting example, the software framework includes pre-trained ML models, ML codes, algorithms, and the like. The multi-level scanning procedure is provided to check for any malware that can be injected into the software framework during the development of the software framework or during the deployment process. The disclosed method ensures that the software framework that passes the security checks at each stage is imported into the end devices. If the vulnerability scan detects vulnerabilities at any stage then files associated with the software framework are placed in a quarantined zone and the deployment process is terminated. The disclosed methodology protects the end devices and makes the end devices cyber-secure. The forthcoming paragraphs will explain the methodology in detail.

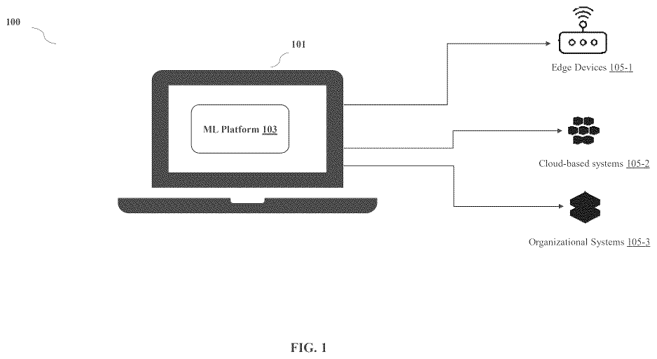

FIG. 1 illustrates an example environment 100 of a system 101, according to an embodiment of the present disclosure. According to an exemplary embodiment, the system 101 is coupled with one or more end devices via a network. In a non-limiting example, the system 101 can include a desktop system, personal computer (PC), laptop, or a computing machine. In a yet further non-limiting example, the one or more end devices include edge devices 105-1, cloud-based systems 105-2, or organizational systems 105-3. The one or more end devices can be collectively labeled as 105 throughout the disclosure. According to an exemplary embodiment, the edge devices 105-1, the cloud-based systems 105-2, and the organizational systems 105-3 include, but are not limited to, industrial Internet of Things (IoT) sensors, industrial controllers, automation systems, monitoring devices, gateways, routers, edge servers, industrial control systems (ICS), and the like.

In an embodiment, the ML platform 103 can be integrated into a cloud-based or web-based environment for securely deploying the software framework. In an embodiment, the ML platform 103 provides deployment capabilities that streamline the process of hosting and serving software framework. According to some embodiments, the ML platform 103 provides features such as model versioning, scalability options, monitoring tools, and integration with other data pipelines or applications. By deploying the software framework within the ML platform 103, organizations can benefit from centralized management, efficient scaling, and easier integration of software framework into their existing systems or end devices 105. The deployed software framework can be used for various applications implemented at the one or more end devices 105. In a non-limiting example, the various applications include predictive maintenance for industrial equipment, analyzing energy efficiency, optimizing energy usage, industrial automation, industrial safety monitoring, and the like.

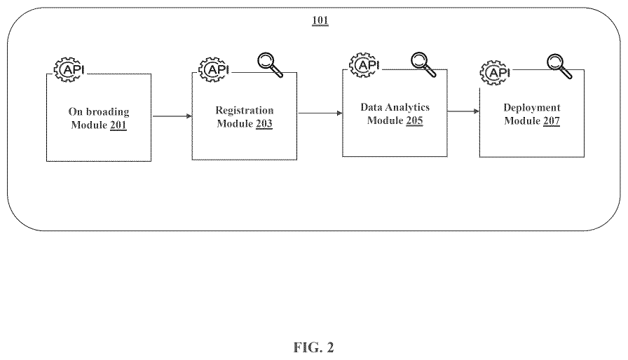

FIG. 2 illustrates a detailed block diagram of the system, according to an embodiment of the present disclosure. According to an embodiment, the system 101 includes an on-boarding module, 201, a registration module 203, a data analytics module 205, and a deployment module 207 coupled with each other. In an embodiment, the on-boarding module, 201, the registration module 203, the data analytics module 205, and the deployment module 207 are uniquely designed hardware or software that are integrated within the ML platform 103. According to some embodiment, the functions of the on-boarding module, 201, the registration module 203, the data analytics module 205, and the deployment module 207 can be performed by one or more processors. According to some embodiments, the on-boarding module, 201, the registration module 203, the data analytics module 205, and the deployment module 207 may be a part of an AI framework of the application to develop AI-powered solutions for specific tasks. An explanation will be made by referring to the modules depicted in FIG. 2. Furthermore, the labels depicted in the representative drawings are kept the same for similar components and operations throughout the disclosure for ease of understanding. The detailed functioning of each module will be explained in the following paragraphs.

According to an embodiment, the software framework that is required to be deployed is at first onboarded into the ML platform 103 of the system 101. In an embodiment, during an on-boarding process, the on-boarding module 201 receives information related to the software framework from either a customer or an operation team. The information related to the software framework can include, but is not limited to, workspace details, and customer details. For example, the workspace details include a workspace identification (ID), a domain ID, a domain name, and the like. Likewise, the customer details include customer ID, tenant ID, and the like. The information related to the software framework is required to link the software framework to a specific domain within the ML platform. In an embodiment, the on-boarding module 201 allocates and links a workspace of the ML platform 103 with a domain using the workspace details by invoking related onboarding APIs. The onboarding APIs facilitate the onboarding process of a given domain within the ML platform 103. Further, the on-boarding module 201 adds the customer to the domain using the customer details by invoking related onboarding customer APIs. The onboarding API facilitates the onboarding process of a given customer within the ML platform 103. Thus, the on-boarding module 201 onboards the software framework into the ML platform 103, allocates the workspace for the provided domain, and adds the customer to the provided domain.

In an embodiment, upon successful completion of the onboarding process, the customer or the operation team sends a request for registering the software framework that is to be deployed with the ML platform 103. Accordingly, the registration module 203 receives the request for registering the software framework with the ML platform 103. The request includes at least a link to the software framework, credentials information, and other relevant information about the software framework. In particular, in the request, the customer or the operation team provides details about the software framework that includes, at least a category of the software framework, analytics name, a global information tracker (GIT) source details, credential information, and other relevant information about the ML project (i.e. the software framework) to perform a registration procedure. For example, the category of the software framework may belong to either the algorithm or the pre-trained ML model. Further, the GIT source details can be a URL of the GIT repository containing the ML code; configuration files; and files associated with the pre-trained ML models, ML code, or algorithm. According to some embodiments, the customer or the operation team can upload, drag and drop the pre-trained ML models, ML code, or algorithm in the ML platforms through user interface (UI). According to an embodiment, the registration module 203 performs the registration procedure for registering and storing the software framework details by invoking related API upon successful onboarding of the on-boarding procedure. The registration module 203, further, sets target environment deployment details, and cluster configurations for the software framework to be deployed, and unzips the uploaded files associated with the pre-trained ML models, ML code, or algorithm. As an example, the target environment deployment details include information about the deployment environment, such as cloud provider details, instance types, and deployment region. Further, the cluster configurations include setting specific configuration parameters related to the computing cluster or environment needed for training and deploying the customer's prediction model. The registration module 203 sets the aforesaid details based on the category of the software framework details. The category of the software framework may belong to either the algorithm or the pre-trained ML model.

According to some embodiments, when the category of the software framework is the pre-trained ML model that is to be deployed, then prior to the registration procedure and after the successful completion of the onboarding procedure, the registration module 203 fetches the files associated with the pre-trained ML model using the link by invoking related fetch and upload APIs. The fetch and upload APIs facilitate fetching and uploading the files. In an embodiment, the registration module 203 uploads the fetched files as zipped artifacts at a Blob database. The Blob database is a type of storage service offered by the cloud providers. The Blob database is designed to store large amounts of unstructured data, such as text or binary data, and is commonly used for serving, managing large files and objects including documents, images, videos, backups, and datasets. Further, the registration module 203 unzips the artifacts to extract the files and performs a pre-registration vulnerability scan at an initial level. In an embodiment, the pre-registration vulnerability scan includes an identification of one or more of malwares, viruses, suspicious behaviors, vulnerabilities, unwanted software, security threats, and risks in the files associated with the pre-trained ML model. In a non-limiting example, the registration module 203 may utilize a Microsoft Defender File scan to perform the pre-registration vulnerability scan. Further, examples of the vulnerability scans as disclosed herein and throughout the disclosure are merely referred for explanatory purposes and should not be construed as limiting. In an embodiment, once the pre-trained ML models successfully pass the pre-registration vulnerability scan, the registration module 203 registers the pre-trained ML model with the ML platform 103 and stores the files associated with the pre-trained ML model in a secured database of the ML platform 103. According to an embodiment, upon conducting a successful pre-registration vulnerability scan, the pre-trained ML model is set for the next level of the scanning procedure. In an embodiment, in case the first-level vulnerability scan is unsuccessful due to identification of any vulnerabilities, the registration module 203 terminates the registration process of the pre-trained ML model and places the files associated with the pre-trained ML model in a quarantine zone.

According to some embodiments, when the category of the software framework is the algorithm or the ML code, the registration module 203 performs the registration process for registering and storing the software framework details by invoking related registration API. The registration API facilitates registration of the algorithm or the ML code with the ML platform 103. Further, the registration module 203 sets target environment deployment details, and cluster configurations for the software framework to be deployed by invoking related association APIs. The association APIs facilitate associating the target environment with the domain of the software framework and setting the cluster configuration for the software framework, and the like.

In an embodiment, the data analytics module 205 performs a first vulnerability scan during the training or importing of the software framework depending on the category of the software framework. According to an embodiment, if the category of the software framework is the pre-trained ML code or the algorithm, then the data analytics module 205 deploys a training job by invoking relevant training API. The training API facilitates training of the pre-trained ML code or the algorithm. In an embodiment, the data analytics module 205 performs the first vulnerability scan during the training of the pre-trained ML code or the algorithm. Likewise, if the category of the software framework is the pre-trained ML model, then the data analytics module 205 deploys an import job and performs the first vulnerability scan during the import of the pre-trained ML model by invoking related import APIs. The import APIs facilitate the importing of files associated with the pre-trained ML model.

In a non-limiting example, in the case of the ML code or the algorithm, the first vulnerability scan identifies one or more of vulnerabilities in open source components, risk in the open source components, compliance issues in the open source components, software defects in the one or more files, and security vulnerabilities in codes of the one or more files. According to a non-limiting example, the data analytics module 205 may utilize a Blackduck Scan, and a Coverity Scan to perform the first vulnerability scan for the ML code or algorithm during a training process.

In a yet further non-limiting example, in the case of the pre-trained ML model, the first vulnerability scan identifies one or more of common vulnerabilities and exposures (CVEs) within the pre-trained ML model, security risks in the pre-trained ML model, drift detection within the pre-trained ML model, vulnerabilities in open source components, risk in the open source components, compliance issues in the open source components, software defects in the one or more files, and security vulnerabilities in codes of the one or more files. According to a non-limiting example, the data analytics module 205 may utilize a model scan, the Blackduck Scan, and the Coverity Scan to perform the first vulnerability scan for the pre-trained ML model during an import process.

In an embodiment, upon successful completion of the first vulnerability scan, the data analytics module 205 sets the software framework for the deployment process. In case the first vulnerability scan is unsuccessful due to the identification of any vulnerabilities, the data analytics module 205 terminates the training process or the import process of the software framework.

According to an embodiment, the data analytics module 205 further determines a vulnerability score associated with each vulnerability issue detected due to the identification of any vulnerabilities. Further, the data analytics module 205 reports a vulnerability score associated with each vulnerability issue for analysis. According to some embodiments, the data analytics module 205 or a system reviewer may perform the analysis. According to an embodiment, the data analytics module 205 disables the first vulnerability scan to proceed with the next level of vulnerability scan if the vulnerability score is within a predefined threshold value.

According to an embodiment, the deployment module 207 performs the deployment process. In an embodiment, for deploying the software framework, the deployment module 207 converts the software framework into deployable files. The deployable files are executable files that are light weight software packages which can be easily deployable. For example, the files associated with the software framework are converted into docker images that can be easily deployable. Further, the deployment module 207 performs a second vulnerability scan on the software framework for identifying one or more of vulnerabilities, risks, and compliance issues in containers associated with the deployable files. Upon successful completion of the second vulnerability scan of the deployable files, the deployment module 207 initiates the deployment process and deploys the software framework into the one or more end devices 105 by invoking related APIs. The related APIs can be, for example, an orchestrator API for storing the software framework, a fetch model artifact API for fetching the files, a setModelTags API for setting the target environment, and an inferenceModel API for performing an inference process. The forthcoming paragraphs will provide a detailed operation flow of the software framework with respect to the category it belongs by referring through FIGS. 1 and 2.

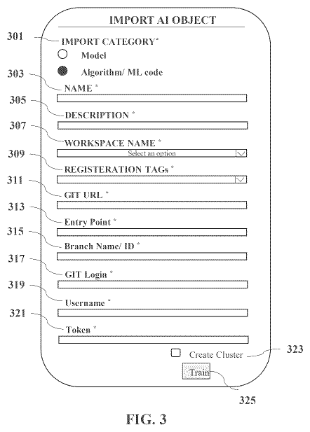

FIG. 3 illustrates an exemplary user interface (UI) for onboarding an ML code or an algorithm, according to an embodiment of the present disclosure. According to an embodiment, FIG. 3 depicts an exemplary UI 300 for onboarding the ML code or the algorithm with the ML platform 103. In an embodiment, as the customer operates upon the ML platform 103 for initiating the deployment process, the UI 300 is displayed to provide details about the ML code or the algorithm. In an embodiment, the customer provides the relevant information about the ML code or the algorithm by selecting and inputting required information about the ML code or the algorithm. The provided information is considered for onboarding the ML code or the algorithm. For example, through tab 301, the customer selects the category of the software framework as the ML code or the algorithm. Further, the customer can provide various other details through the UI 300. According to an example embodiment, a name of the algorithm or the ML code can be provided through tab 303. Further, a description about the algorithm or the ML code can be provided through a tab 305. Likewise, through tabs 307 to 321, details about the workspace name, registration tags, GIT URLs, entry point, branch name/ID, GIT login, username, and token can be provided. Further, based on the provided details, the on-boarding module 201 and the registration module 203 onboards and registers the ML code or the algorithm with the AI platform 103. Further, by selecting a tab 323 a command to create a cluster can be provided to the registration module 203 for setting the cluster configuration where the ML code or the algorithm can be trained. The registration module 203 further fetches training parameters and training configurations for training the ML code or the algorithm. According to an embodiment, a tab 325 provides a command to train the ML code or the algorithm to the data analytics module 205. Subsequently, the first vulnerability scan and the second vulnerability scan are performed during the training and the deployment procedures upon successful scanning at each level.

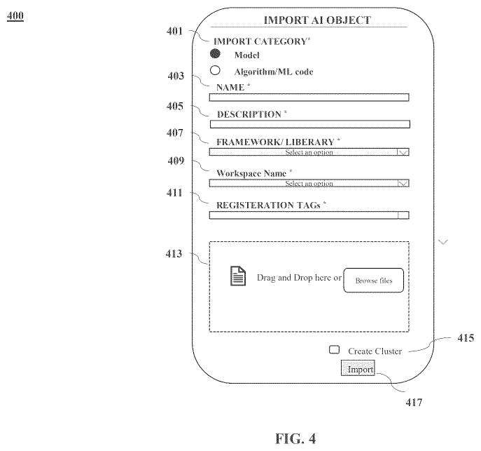

FIG. 4 illustrates an exemplary user interface (UI) 400 for onboarding a pre-trained ML model, according to an embodiment of the present disclosure. According to an embodiment, FIG. 4 depicts an exemplary UI 400 for onboarding the pre-trained ML model with the ML platform 103. In an embodiment, as the customer operates upon the ML platform 103 for initiating the deployment process, the UI 400 is displayed to provide details about the pre-trained ML model. In an embodiment, the customer provides the relevant information about the pre-trained ML model by selecting and inputting required information about the pre-trained ML model. The provided information is considered for onboarding the pre-trained ML model. As depicted in FIG. 4, through a tab 401, the customer has selected the category of the software framework as the pre-trained ML model. Likewise, the customer can provide various other details. According to an example embodiment, a name of the pre-trained ML model can be provided through tab 403. Further, a description about the pre-trained ML model can be provided through a tab 405. Likewise, through tabs 407 to 411, details about a framework/library, the workspace name, and the registration tags can be provided.

According to an embodiment, based on the details like the category, name and the description of the pre-trained ML model, the on-boarding module 201 on-boards the pre-trained ML model with the ML platform 103. Further, upon successful onboarding, the on-boarding module 201 sets the ML model for the registration process. In an embodiment, through the tab 413, the files associated with the pre-trained ML model are uploaded by either performing drag and drop operation or by browsing the provided link. Further, the registration module 203 receives the framework/Library details, the workspace name, and registration tags through the tabs 407, 409, and 411 respectively. In an embodiment, after successful on-boarding of the pre-trained ML model and prior to the registration, the pre-registration vulnerability scan is performed by the registration module 203. On the success of the pre-registration vulnerability scan, the registration module 203 registers the pre-trained ML model. According to a further embodiment, through a tab 415 a command to create a cluster is provided to the registration module 203 for setting an environment where the pre-trained ML model can be imported. According to an embodiment, the tab 417 provides a command to import the pre-trained ML model. Subsequently, the first vulnerability scan and the second vulnerability scan are performed during the import and the deployment procedures upon successful scanning at each level.

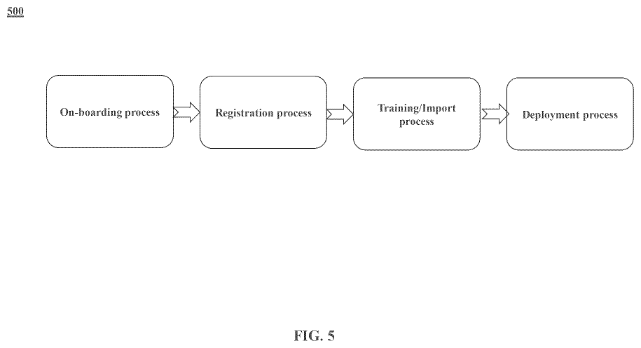

FIG. 5 illustrates general operation steps of the deployment process 500, according to an embodiment of the present disclosure. In an embodiment, the deployment process 500 of the software framework with the ML platform 103, primarily includes the following steps:
On-boarding process
Registration process
Training process/Import process
Deployment process

In an embodiment, various vulnerability scans are deployed during the above processes for securely deploying the software framework. Thus, providing an effective way to secure the deployment process of the software framework. A detailed explanation of each of the processes will be explained in the forthcoming paragraphs.

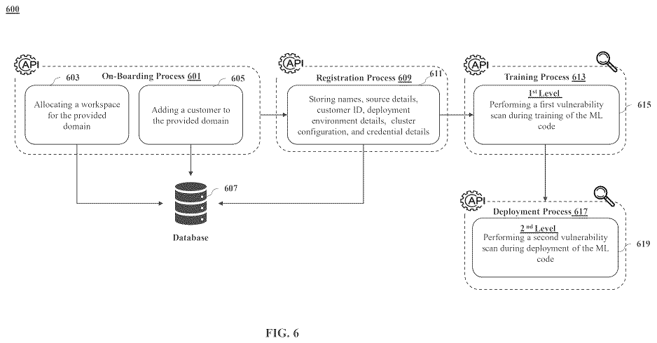

FIG. 6 illustrates an operation flow 600 for secure deployment of an ML code or algorithm with an ML platform, according to an embodiment of the present disclosure. The operation flow 600 will be explained by taking an example of the ML code that is to be deployed.

In an embodiment, during the on-boarding process 601, the on-boarding module 201 receives information related to the ML code from either the customer or the operation team using the UI 300 of FIG. 3 as explained above. The information includes at least the workspace identification (ID), the domain ID, the domain name, the customer ID, of the ML code. As explained above, based on the above details, at block 603, the on-boarding module 201 performs the on-boarding process 601. In an embodiment, the on-boarding process 601 includes allocating the workspace and then linking the workspace with the provided domain by invoking related onboarding APIs. According to an embodiment, based on the received information, the on-boarding module 201 allocates a workspace for the provided domain and then links the workspace with the provided domain. According to an embodiment, the related onboarding APIs are implemented in the on-boarding module 201. Further, the on-boarding module 201, at block 605, adds the customer to the domain based on the customer ID and by invoking the related onboarding customer APIs. In an embodiment, the related onboarding customer APIs are implemented in the on-boarding module 201. According to a further embodiment, the workspace details and the customer details as provided during the on-boarding process 601 are stored in the database 607.

In an embodiment, upon successful completion of the on-boarding process 601, the customer or the operation team sends the request for registering the ML code with the ML platform 103. The registration module 203 performs the registration process 609. According to an embodiment, during the registration process 609, the registration module 203 receives the request for registering the ML code with the ML platform 103. In an embodiment, the registration module 203 receives the details about the software framework through the UI 300 of FIG. 3 as explained above. The details about the software framework include at least the category of the software framework, the analytics name, the GIT source details, the credential information, and other relevant information about the ML code to perform the registration process 609. In an embodiment, the registration module 203 identifies the category of the software framework to be deployed on the ML platform 103 based on the received details about the software framework. In the current example embodiment, the registration module 203 identifies the category of the software framework as the ML code. Further, the registration module 203 sets the target environment deployment details, the cluster configurations of the ML code based on the information received during the on-boarding process 601 and the registration process 609. In an embodiment, the registration module 203 further associate the ML code with a respective training pipeline and assigns a training ID and an association ID to the registered ML code. According to an embodiment, the registration module 203, at block 611, stores the analytics name, the GIT source details, the credential information, the target deployment environment details, the cluster configuration details, the association details in the database 607. Table 1 depicts an example of various details that are obtained through the on-boarding process and the registration process and stored in the database.

TABLE 1

Analytic Name: “IndustrialSensorBehaviorMonitor_v1”
Domain ID: “industrial_monitoring_domain_123”
Customer ID: “customer_xyz_789”
Workspace ID: “workspace_abc_456”
Credential Details:
Username: “user123”
Password: [encrypted]
API Key: “apikey_xyz123”
Target Deployment Detail:
Cloud Provider: Amazon Web Services (AWS)
Region: US region
Storage: 100GB
Security Group: industrial-sensor-monitoring-sg
Cluster Configuration Details:
Number of Nodes: 3
Node Type: “medium-sized general-purpose instance type”
Node Configuration: 2 vCPUs, 8GB RAM
Load Balancer: load-balancer-application
CPU utilization Threshold: 70%
Git Source Details:
Repository Name: industrial-monitoring-ml
Source URL:
https://github.com/yourusername/industrial-monitoring-ml.git
Branch: main
Tag: v1.0.0
Pipeline ID: 123456
Association ID: ml-industrial-monitoring-association-56789

Upon successful registration of the ML code, the data analytics module 205 performs the training process 613. In an embodiment, the data analytics module 205 fetches details like the association ID and the workspace ID from the database 607. Based on the fetched details, the data analytics module 205 deploys a training job by invoking relevant training API. In an embodiment, the data analytics module 205 access the files associated with the ML code from the GIT source by using the link and credential details provided during the registration process 609. Accordingly, the data analytics module 205 starts the training of the ML code with all the details provided during the registration process 609.

According to an embodiment, the data analytics module 205, at block 615, performs the first vulnerability scan on the files associated with the ML code during the training of the ML code. In an embodiment, the first vulnerability scan is a first level scan when the software framework to be deployed is the ML code. In an embodiment, at the first level scan, the first vulnerability scan identifies at least one or more of vulnerabilities in open source components, risk in the open source components, compliance issues in the open source components, software defects in the one or more files, and security vulnerabilities in codes of the files. As an example, the first vulnerability scan includes the Blackduck Scan and the Coverity scan.

According to an embodiment, the data analytics module 205 updates the scan_status flag as ‘true’, upon the success of the first vulnerability scan at the first level. Further, the data analytics module 205 sets the ML code for the deployment process. According to an embodiment, in case the data analytics module 205 identifies any vulnerabilities based on the first vulnerability scan, the data analytics module 205 updates the scan_status flag as ‘false’ to indicate that the first vulnerability scan has become unsuccessful and vulnerability issues have been detected. In such a case the data analytics module 205 determines a vulnerability score associated with each vulnerability issue based on the first vulnerability scan. Further, the data analytics module 205 reports the vulnerability score and vulnerability issues for analysis. According to some embodiments, the data analytics module 205 or a system reviewer may perform the analysis based on the vulnerability score. Thus, based on the result of the analysis, if the vulnerability score is determined to be within the threshold value, then the data analytics module 205 or the system reviewer disables the first vulnerability scan to proceed with the next level i.e. with the deployment process where the second vulnerability scan is performed.

According to an embodiment, based on the result of analysis, if the vulnerability score is determined to be above the threshold value, then the data analytics module 205 or the system reviewer reports the vulnerability issue to the customer to resolve the vulnerability issues. The customer sends back a defect-free ML code having updated files to proceed with the second vulnerability scan on it. In case the vulnerability issue is unresolved, then the data analytics module 205 or the system reviewer terminates the second vulnerability scan, and thereby terminating the deployment process of the ML code.

According to an embodiment, upon success of the first vulnerability scan, the data analytics module 205 sets the ML code for deployment process. Further, the data analytics module 205 updates a training_status_flag indicating a completion of the training of the ML code or not. According to an embodiment, the deployment module 207 converts the one or more files associated with the ML code into one or more deployable files for deployment with the ML platform 103. In an embodiment, the deployment module 207, at block 619, performs the second vulnerability scan on the one or more deployable files to identify one or more of vulnerabilities, risks, and compliance issues in containers associated with the one or more deployable files. In a non-limiting example, the second vulnerability scan includes the Twistlock scan. The second vulnerability scan is the next level scan after the training process 613.

According to an embodiment, upon success of the second vulnerability scan, the deployment module 207 updates the twistlock_flag_status as ‘true’. Further, the deployment module 207 checks the training_status_flag before processing the deployable files. In an embodiment, upon success of the training of the ML code, the training_status_flag is updated as ‘true’. Based on a status of the training_status_flag as ‘true’, the deployment module 207 sets the deployment target environment. Further, the deployment module 207 initiates the deployment process. In an embodiment, after completion of the deployment process 617, the ML model that is generated based on the ML code is ready for serving or invocation by the end devices 105.

According to an embodiment, in case the second vulnerability scan becomes unsuccessful, then the deployment module 207 updates the twistlock_flag_status as ‘false’. Further, the deployment module 207 terminates the deployment process 617.

According to some embodiment, the deployment module 207 may initiates an on-demand deployment of the ML code by invoking related APIs like orchestrator API.

According to an embodiment, the operation steps as explained in FIG. 6 are applicable for the software framework such as algorithms. Therefore, for the sake of brevity, a details explanation of the operation steps for the same is being omitted here. Thus, in a case when the software frameworks that are required to be deployed are the algorithms or the ML codes, a two-level scan is performed at various stages of deployment, i.e. during the training process and the deployment process. By adapting an approach as explained above, the software framework is securely deployed with the ML platform.

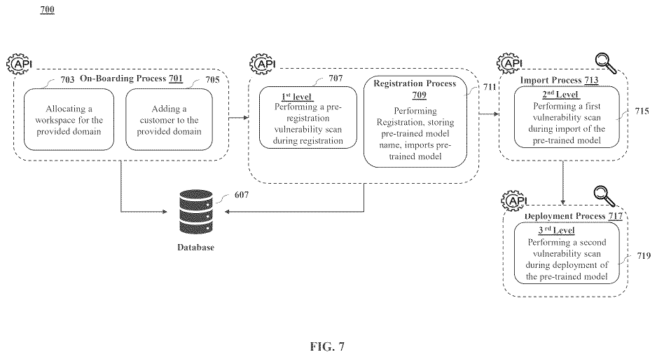

FIG. 7 illustrates an operation flow 700 for a secure deployment of a pre-trained ML model with an ML platform, according to an embodiment of the present disclosure. In an embodiment, during the on-boarding process 701, the on-boarding module 201 receives information related to the pre-trained ML model from either the customer or the operation team using the UI 400 as explained in FIG. 4 above. The information includes at least the workspace identification (ID), the domain ID, the domain name, the customer ID, of the pre-trained ML model. As explained above, based on the above details, at block 703, the on-boarding module 201 performs the on-boarding process 701. In an embodiment, the on-boarding process 701 includes allocating the workspace and then linking the workspace with the provided domain by invoking related onboarding APIs. According to an embodiment, based on the received information, the on-boarding module 201 allocates a workspace for the provided domain and then links the workspace with the provided domain. According to an embodiment, the related onboarding APIs are implemented in the on-boarding module 201. Further, the on-boarding module 201, at block 705, adds the customer to the domain based on the customer ID and by invoking the related onboarding customer APIs. In an embodiment, the related onboarding customer APIs are implemented in the on-boarding module 201. According to a further embodiment, the workspace details and the customer details as provided during the on-boarding process 601 are stored in the database 607.

In an embodiment, upon successful completion of the on-boarding process 701, the registration module 203 sets the pre-trained ML model for the registration process 709. In an embodiment, the registration module 203 receives the request for registering the ML model with the ML platform 103. In an embodiment, the registration module 203 receives further details like the link to fetch the files associated with the pre-trained ML model, library/framework details through the UI 400 of FIG. 4 as explained above. Accordingly, the registration module 203, prior to the registration process 709, fetches the files associated with the pre-trained ML model using the link by invoking related fetch and upload APIs. The fetch and upload APIs facilitate fetching and uploading the files. In an embodiment, the registration module 203 uploads the fetched files as zipped artifacts at the Blob database (not shown). Further, the registration module 203 unzips artifacts to extract the files and performs the pre-registration vulnerability scan at a first level. In an embodiment, at block 707, the registration module 203 performs the pre-registration vulnerability scan for identifying one or more of malwares, viruses, suspicious behaviors, vulnerabilities, unwanted software, security threats, and risks in the files associated with the pre-trained ML model. In a non-limiting example, the pre-registration vulnerability scan includes the Microsoft Defender File scan to perform the first level scan.

According to an embodiment, once the pre-trained ML model successfully passes the pre-registration vulnerability scan, the registration module 203 proceeds with the completion of the registration process 709. In an embodiment, the registration module 203, at block 711, registers the pre-trained ML model with the ML platform 103 and stores the files associated with the pre-trained ML model and other details in the database 607 which is a secured database of the ML platform 103. Further, the registration module 203 upon successful registration updates the file_scan_status flag as ‘true’. Furthermore, the registration module 203 sets the pre-trained ML model for the import process 713. According to an embodiment, in case, the pre-registration vulnerability scan becomes unsuccessful then, the registration module 203 terminates the registration process 709 of the pre-trained ML model and thereby terminates the deployment process 500.

In an embodiment, the data analytics module 205, deploys the import job by invoking import model APIs to proceed with the import process 713. In an embodiment, the data analytics module 205, fetches the details of the pre-trained ML model and imports the files from the database 607 for performing the first vulnerability scan at a second level. According to an embodiment, the data analytics module 205, at block 715, performs the first vulnerability scan for identifying the one or more of CVEs within the pre-trained ML model, security risks the pre-trained ML model, drift detection within the pre-trained ML model, vulnerabilities in open source components, risk in the open source components, compliance issues in the open source components, software defects in the one or more files, and security vulnerabilities in codes of the one or more files. According to a non-limiting example, the first vulnerability scan includes the model scan, the Blackduck Scan, and the Coverity Scan. According to an embodiment, the data analytics module 205 updates the scan_status flag as ‘true’, upon the success of the first vulnerability scan at the second level. Further, the data analytics module 205 sets the pre-trained ML model for the deployment process 717.

According to an embodiment, in case the data analytics module 205 identifies any vulnerabilities based on the first vulnerability scan, the data analytics module 205 updates the scan_status flag as ‘false’ to indicate that the first vulnerability scan has become unsuccessful and vulnerability issues have been detected. In such a case the data analytics module 205 further determines the vulnerability score associated with each vulnerability issue based on the first vulnerability scan. Further, the data analytics module 205 reports the vulnerability score and vulnerability issues for analysis. According to some embodiments, the data analytics module 205 or the system reviewer may perform the analysis based on the vulnerability score. Thus, based on the result of the analysis, if the vulnerability score is determined to be within the threshold value, then the data analytics module 205 or the system reviewer disables the first vulnerability scan to proceed with the next level i.e. with the deployment process where the second vulnerability scan is performed.

According to an embodiment, based on the result of analysis, if the vulnerability score is determined to be above the threshold value, then the data analytics module 205 or the system reviewer reports the vulnerability issue to the customer to resolve the vulnerability issues. The customer sends back a defect-free pre-trained ML model having updated files to proceed with the next level scan i.e. the second vulnerability scan on the updated files. In case the vulnerability issue is unresolved, then the data analytics module 205 or the system reviewer terminates the next level scan i.e. the second vulnerability scan, and thereby terminating the deployment process of the pre-trained ML model.

According to an embodiment, upon success of the first vulnerability scan, the data analytics module 205 sets the pre-trained ML model for deployment process. Further, the data analytics module 205 updates an import_status_flag indicating a completion of the import of the pre-trained ML model or not. According to an embodiment, the deployment module 207 converts the one or more files associated with the pre-trained ML model into one or more deployable files for deployment with the ML platform 103. In an embodiment, the deployment module 207, at block 719, performs the second vulnerability scan on the one or more deployable files to identify one or more of vulnerabilities, risks, and compliance issues in containers associated with the one or more deployable files. In a non-limiting example, the second vulnerability scan includes the Twistlock scan. The second vulnerability scan is the next level scan after the importing process 713.

According to an embodiment, upon success of the second vulnerability scan, the deployment module 207 updates the twistlock_flag_status as ‘true’. Further, the deployment module 207 checks the import_status_flag before processing the deployable files. In an embodiment, upon success of the import of the pre-trained ML model, the import_status_flag is updated as ‘true’. Based on a status of the import_status_flag as ‘true’, the deployment module 207 sets the deployment target environment. Further, the deployment module 207 initiates the deployment process. In an embodiment, after completion of the deployment process 717, the pre-trained ML model is ready for serving or invocation by the end devices 105.

According to some embodiment, the deployment module 207 may initiate an on-demand deployment of the pre-trained ML model by invoking related APIs like orchestrator API.

Thus, in a case when the software framework that is required to be deployed is the pre-trained ML model, a three-level scan is performed at various stages of deployment, i.e. before the registration process, during the training process, and the deployment process. By adapting an approach as explained above, the software framework is securely deployed with the ML platform.

According to an embodiment, in case the second vulnerability scan becomes unsuccessful, then the deployment module 207 updates the twistlock_flag_status as ‘false’. Further, the deployment module 207 terminates the deployment process 617.

According to some embodiment, the software framework i.e. either the ML code, algorithm, or the ML model is written or developed at a secured workspace, or in a secured computational notebook environment. In such a scenario, the initial level vulnerability scan is being performed during the deployment process. According to an exemplary embodiment, the deployment module 207 performs the second vulnerability scan during the deployment process to identify one or more of vulnerabilities, risks, and compliance issues in containers associated with the one or more deployable files. In a non-limiting example, the second vulnerability scan includes the Twistlock scan.

According to an embodiment, upon success of the second vulnerability scan, the deployment module 207 updates the twistlock_flag_status as ‘true’. Further, the deployment module 207 checks the import_status_flag before processing the deployable files. The deployment module 207 further sets the deployment target environment. Further, the deployment module 207 initiates the deployment process. In an embodiment, after completion of the deployment process, the software framework is ready for serving or invocation by the end devices 105. According to an embodiment, in case the second vulnerability scan becomes unsuccessful, then the deployment module 207 updates the twistlock_flag_status as ‘false’. Further, the deployment module 207 terminates the deployment process of the software framework.

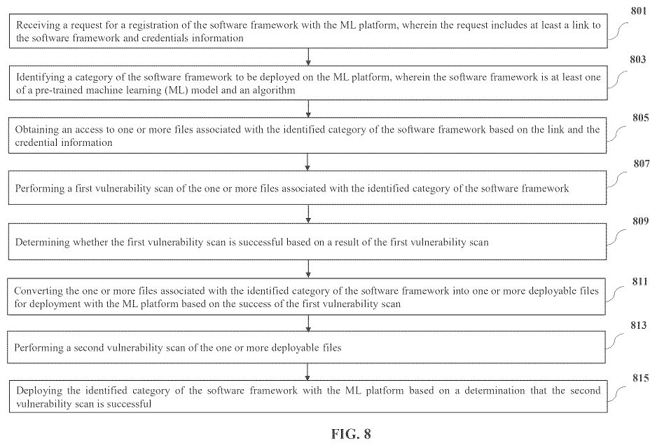

FIG. 8 illustrates a flow chart for a method for securely deploying the software framework in the ML platform, according to an embodiment of the present disclosure. The method 800 is implemented in the system 101 of FIGS. 1 and 2. Further, steps of the method 800 are explained in detail through FIGS. 2 to 7, therefore for the sake of brevity, the detailed explanation has been omitted here.

In an embodiment, the system 101 commence with on-boarding of the software framework. The on-boarding process is being performed by the on-boarding module 201. Further, the method proceeds with the registration process.

According to an embodiment, the method 800, at step 801 includes receiving a request for a registration of the software framework with the ML platform 103, where the request includes at least a link to the software framework and credentials information.

Further, the method 800, at step 803 includes identifying a category of the software framework to be deployed on the ML platform, where the software framework is at least one of a pre-trained machine learning (ML) model and an algorithm. In an embodiment, the steps 801 and 803 are performed by the registration module 203.

Further, the method 800, at step 805 includes obtaining an access to one or more files associated with the identified category of the software framework based on the link and the credential information.

Further, the method 800, at step 807, includes performing the first vulnerability scan of the one or more files associated with the identified category of the software framework. In an embodiment, when the category of the software framework is identified as the algorithm, the first vulnerability scan includes identifying one or more of vulnerabilities in open source components, risk in the open source components, compliance issues in the open source components, software defects in the one or more files, and security vulnerabilities in codes of the one or more files.

Further, in an embodiment, when the category of the software framework is identified as the pre-trained ML model, the first vulnerability scan includes identifying one or more of common vulnerabilities and exposures (CVEs) within the pre-trained ML model, security risks the pre-trained ML model, drift detection within the pre-trained ML model, vulnerabilities in open source components, risk in the open source components, compliance issues in the open source components, software defects in the one or more files, and security vulnerabilities in codes of the one or more files. According to an embodiment, the first vulnerability scan is performed by the data analytics module 205.

Further, the method 800, at step 809, includes determining whether the first vulnerability scan is successful based on a result of the first vulnerability scan. According to an embodiment, based on the determination that the first vulnerability scan is unsuccessful, the method 800 further includes reporting vulnerabilities issues associated with the software framework to a user for fixing the vulnerability issues, further receiving an updated software framework having one or more updated files, wherein the updated software framework is free from the vulnerability issues and proceeding with the second vulnerability scan on the one or more updated files.

According to some embodiments, based on the determination that the first vulnerability scan is unsuccessful, the method 800 further comprises determining a vulnerability score associated with each vulnerability issue detected based on the first vulnerability scan. The further includes reporting the vulnerability score for analysis and disabling the first vulnerability scan to proceed with the second vulnerability scan based on a result of the analysis that the vulnerability score is within a predefined threshold value. According to an embodiment, based on the result of the analysis that the vulnerability score is above the predefined threshold value, the method 800 further includes terminating the next scan i.e. the second vulnerability scan of the software framework. According to an embodiment, the step 809 is performed by the data analytics module 205.

According to a further embodiment, the method 800, at step 811, includes converting the one or more files associated with the identified category of the software framework into one or more deployable files for deployment with the ML platform based on the success of the first vulnerability scan. In an embodiment, the step 811 is being performed by the deployment module 207.

Further, the method 800, at step 813, includes performing the second vulnerability scan of the one or more deployable files. In an embodiment, when the category of the software framework is identified as the pre-trained ML model or the algorithm the second vulnerability scan includes identifying one or more of vulnerabilities, risks, and compliance issues in containers associated with the one or more deployable files. In an embodiment, the method 800 further includes terminating the deployment of the software framework based on the determination that the second vulnerability scan is unsuccessful. In an embodiment, the second vulnerability scan is performed by the deployment module 207.

In an embodiment, when the category of the software framework is identified as the pre-trained ML model, the method 800 further comprises performing a third vulnerability scan on the one or more files prior to the registration. The third vulnerability scan can be alternately referred to as the ‘pre-registration vulnerability scan’ throughout the disclosure. As an example, the third vulnerability scan includes identification of one or more of malwares, viruses, suspicious behaviors, vulnerabilities, unwanted software's, security threats, and risks in the one or more files. Further, the method includes determining whether the third vulnerability scan is successful based on a result of the third vulnerability scan and proceeding with the first vulnerability scan based on the determination that the third vulnerability scan is successful. In an embodiment, the third vulnerability scan is performed by the registration module 203.

Further, the method 800, at step 815, includes deploying the identified category of the software framework with the ML platform based on a determination that the second vulnerability scan is successful.

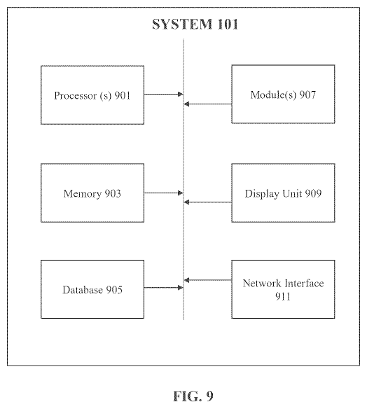

FIG. 9 illustrates a general block diagram of the system 101, according to an embodiment of the present disclosure. For an example, the processor(s) 901 may be a single processing unit or a number of units, all of which could include multiple computing units. The processor(s) 901 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 901 is configured to fetch and execute computer-readable instructions and data stored in the memory 903.

The memory 903 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 907 may include a program, a subroutine, a portion of a program, a software component, or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 907 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 907 when executed by the processor(s) 901 may be configured to perform any of the described functionalities. According to an embodiment, the module 907 includes the on-boarding module 201, the registration module 203, the data analytics module 205, and the deployment module 207. In an alternate embodiment, the functions of the aforesaid modules may be performed by the processor(s) 901.

As a further example, the database 905 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 901, and the modules/engines/units 907.

The modules/engines/units 907 may be implemented with an AI module that may include a plurality of neural network layers. Examples of neural networks include, but are not limited to, a convolutional neural network (CNN), a deep neural network (DNN), a recurrent neural network (RNN), and a Restricted Boltzmann Machine (RBM). The learning technique is a method for training a predetermined target device using a plurality of learning data to cause, allow, or control the target device to make a determination or prediction. Examples of the learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 909 includes a computer monitor, a touch screen, an output device capable of displaying the graphics, and the like. The display unit 909 is configured to display visual output in desktops, laptops, and workstations. The display unit 909 may come in different sizes, resolutions, and types (such as LCD, LED, or OLED).

As a further example, the network interface 911 is configured to provide and establish communication with any electronic device via a public network, private network, or any wireless communication technology.

The disclosed technique, provides an improved method of identifying potential issues, and vulnerabilities at a granular level by deploying multiple scanning procedures at multiple stages of deployment of the software framework. This helps in securely deploying or executing an external software framework in end devices like edge devices, cloud-based systems, organizational devices, and the like.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and methods are set forth to provide a full understanding of the example embodiments. One of the ordinary skills in the art recognize the example embodiments that can be practiced without one or more specific details and/or with other methods.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

We claim:

1. A method for secure deployment of a software framework on a Machine Learning (ML) platform, the method comprising:
receiving a request for a registration of the software framework with the ML platform, wherein the request includes at least a link to the software framework and credentials information;
identifying a category of the software framework to be deployed on the ML platform, wherein the software framework is at least one of a pre-trained machine learning (ML) model and an algorithm;
obtaining an access to one or more files associated with the identified category of the software framework based on the link and the credential information;
performing a first vulnerability scan of the one or more files associated with the identified category of the software framework;
determining whether the first vulnerability scan is successful based on a result of the first vulnerability scan;
converting the one or more files associated with the identified category of the software framework into one or more deployable files for deployment with the ML platform based on the success of the first vulnerability scan;
performing a second vulnerability scan of the one or more deployable files; and
deploying the identified category of the software framework with the ML platform based on a determination that the second vulnerability scan is successful.

2. The method of claim 1, wherein when the category of the software framework is identified as the pre-trained ML model, the method comprises:
performing a third vulnerability scan on the one or more files prior to the registration, wherein the third vulnerability scan includes identification of one or more of malwares, viruses, suspicious behaviors, vulnerabilities, unwanted softwares, security threats, and risks in the one or more files;
determining whether the third vulnerability scan is successful based on a result of the third vulnerability scan; and
proceeding with the first vulnerability scan based on the determination that the third vulnerability scan is successful.

3. The method of claim 2, further comprising:
terminating the registration of the software framework based on the determination that the third vulnerability scan is unsuccessful.

4. The method of claim 1, further comprising:
terminating the deployment of the software framework based on the determination that the second vulnerability scan is unsuccessful.

5. The method of claim 1, wherein based on the determination that the first vulnerability scan is unsuccessful, the method comprises:
reporting vulnerabilities issues associated with the software framework to a user for fixing the vulnerability issues;
receiving an updated software framework having one or more updated files, wherein the updated software framework is free from the vulnerability issues; and
proceeding with the second vulnerability scan on the one or more updated files.

6. The method of claim 1, wherein based on the determination that the first vulnerability scan is unsuccessful, the method further comprises:
determining a vulnerability score associated with each vulnerability issue detected based on the first vulnerability scan;
reporting the vulnerability score for analysis; and
disabling the first vulnerability scan to proceed with the second vulnerability scan based on a result of the analysis that the vulnerability score is within a predefined threshold value.

7. The method of claim 6, further comprising: terminating the second vulnerability scan of the software framework based on the result of the analysis that the vulnerability score is above the predefined threshold value.

8. The method of claim 1, wherein when the category of the software framework is identified as the algorithm, the first vulnerability scan includes identifying one or more of vulnerabilities in open source components, risk in the open source components, compliance issues in the open source components, software defects in the one or more files, and security vulnerabilities in codes of the one or more files.

9. The method of claim 1, wherein when the category of the software framework is identified as the pre-trained ML model, the first vulnerability scan includes identifying one or more of common vulnerabilities and exposures (CVEs) within the pre-trained ML model, security risks in the pre-trained ML model, drift detection within the pre-trained ML model, vulnerabilities in open source components, risk in the open source components, compliance issues in the open source components, software defects in the one or more files, and security vulnerabilities in codes of the one or more files.

10. The method of claim 1, wherein when the category of the software framework is identified as the pre-trained ML model or the algorithm the second vulnerability scan includes identifying one or more of vulnerabilities, risks, and compliance issues in containers associated with the one or more deployable files.

11. A system for secure deployment of a software framework on a Machine Learning (ML) platform, the system comprising:
one or more processors;
a memory; and
one or more programs stored in the memory, the one or more programs when executed by the one or more processors cause the one or more processors to:
receive a request for a registration of the software framework with the ML platform, wherein the request includes at least a link to the software framework and credentials information;
identify a category of the software framework to be deployed on the ML platform, wherein the software framework is at least one of a pre-trained machine learning (ML) model and an algorithm;
obtain an access to one or more files associated with the identified category of the software framework based on the link and the credential information;
perform a first vulnerability scan of the one or more files associated with the identified category of the software framework;
determine whether the first vulnerability scan is successful based on a result of the first vulnerability scan;
convert the one or more files associated with the identified category of the software framework into one or more deployable files for deployment with the ML platform based on the success of the first vulnerability scan;
perform a second vulnerability scan of the one or more deployable files; and
deploy the identified category of the software framework with the ML platform based on a determination that the second vulnerability scan is successful.

12. The system of claim 11, wherein when the category of the software framework is identified as the pre-trained ML model, the one or more processors are further configured to:
perform a third vulnerability scan on the one or more files prior to the registration, wherein the third vulnerability scan includes identification of one or more of malwares, viruses, suspicious behaviors, vulnerabilities, unwanted softwares, security threats, and risks in the one or more files;
determine whether the third vulnerability scan is successful based on a result of the third vulnerability scan; and
proceed with the first vulnerability scan based on the determination that the third vulnerability scan is successful.

13. The system of claim 12, wherein the one or more processors are further configured to:
terminate the registration of the software framework based on the determination that the third vulnerability scan is unsuccessful.

14. The system of claim 11, wherein the one or more processors are further configured to:
terminate the deployment of the software framework based on the determination that the second vulnerability scan is unsuccessful.

15. The system of claim 11, wherein based on the determination that the first vulnerability scan is unsuccessful, the one or more processors are further configured to:
report vulnerabilities issues associated with the software framework to a user for fixing the vulnerability issues;
receive an updated software framework having one or more updated files, wherein the updated software framework is free from the vulnerability issues; and
proceed with the second vulnerability scan on the one or more updated files.

16. The system of claim 11, wherein based on the determination that the first vulnerability scan is unsuccessful, the one or more processors are further configured to:
determine a vulnerability score associated with each vulnerability issue detected based on the first vulnerability scan;
report the vulnerability score for analysis; and
disable the first vulnerability scan to proceed with the second vulnerability scan based on a result of the analysis that the vulnerability score is within a predefined threshold value.

17. The system of claim 11, wherein when the category of the software framework is identified as the algorithm, the first vulnerability scan includes identifying one or more of vulnerabilities in open source components, risk in the open source components, compliance issues in the open source components, software defects in the one or more files, and security vulnerabilities in codes of the one or more files.

18. The system of claim 11, wherein when the category of the software framework is identified as the pre-trained ML model, the first vulnerability scan includes identifying one or more of common vulnerabilities and exposures (CVEs) within the pre-trained ML model, security risks in the pre-trained ML model, drift detection within the pre-trained ML model, vulnerabilities in open source components, risk in the open source components, compliance issues in the open source components, software defects in the one or more files, and security vulnerabilities in codes of the one or more files.

19. The system of claim 11, wherein when the category of the software framework is identified as the pre-trained ML model or the algorithm the second vulnerability scan includes identifying one or more of vulnerabilities, risks, and compliance issues in containers associated with the one or more deployable files.

20. A non-transitory computer-readable storage medium storing program instructions for secure deployment of a software framework on a Machine Learning (ML) platform, the program instructions, when executed, perform the steps of:
receiving a request for a registration of the software framework with the ML platform, wherein the request includes at least a link to the software framework and credentials information;
identifying a category of the software framework to be deployed on the ML platform, wherein the software framework is at least one of a pre-trained machine learning (ML) model and an algorithm;
obtaining an access to one or more files associated with the identified category of the software framework based on the link and the credential information;
performing a first vulnerability scan of the one or more files associated with the identified category of the software framework;
determining whether the first vulnerability scan is successful based on a result of the first vulnerability scan;
converting the one or more files associated with the identified category of the software framework into one or more deployable files for deployment with the ML platform based on the success of the first vulnerability scan;
performing a second vulnerability scan of the one or more deployable files; and
deploying the identified category of the software framework with the ML platform based on a determination that the second vulnerability scan is successful.
